(19) United States
(12) Patent Application Publication
(10) Pub. No.: US 2003/0142945 A1
(43) Pub. Date: Jul. 31, 2003

(54) Method and system for attaching one or more optical fibers to a retaining device

(76) Inventors: Joseph L. Dallas, Maple Glen, PA (US); Angelique X. Irvin, Radnor, PA (US); Robert W. Irvin, Radnor, PA (US); Ralph S. Jameson, Orefield, PA (US); William A. Mamakos, Laurel, MD (US)

Correspondence Address: CANTOR COLBURN, LLP, 55 GRIFFIN ROAD SOUTH, BLOOMFIELD, CT, 06002

(21) Appl. No.: 10/058,367

(22) Filed: Jan. 28, 2002

(51) Int. Cl. G02B 6/00

(52) U.S. Cl. 385/137

(57) ABSTRACT

A method is provided for attaching one or more optical fibers to a retaining device. The method includes: applying a fluid to a through hole in a retaining device; disposing an optical fiber proximate an end of the through hole; developing a differential pressure in the fluid across the through hole; drawing a portion of the optical fiber into the through hole using a force associated with said differential pressure.

### BACKGROUND

The present invention relates to optical fibers, and more particularly, to a method for attaching one or more optical fibers to a retaining device.

In practical fiber optic systems, optical fibers may be secured within retaining devices such as capillary tubes or multi-fiber array substrates. The assembly of the optical fibers to these and other retaining devices typically requires manual insertion of the optical fiber within the retaining device. The standard processes for assembly of multi-fiber arrays and fiber capillaries can be described in further detail with reference to FIG. 1 and FIG. 2, respectively.

Referring to FIG. 1, a cross-sectional, perspective view is provided for illustrating a typical multi-fiber array 100. Two substrates, upper and lower substrates 102, 104 are stacked, and multiple optical fibers 106 are arranged in parallel between the two substrates 102, 104. As shown in FIG. 1, the upper and lower substrates 102, 104 each have a surface on which V-shaped grooves 108 are formed. The grooves 108 on the bottom surface of the upper substrate 102 are respectively mated with the grooves 108 on the top surface of the lower substrate 104. The optical fibers 106 are manually placed between the respective V-grooves 108 of the upper and lower substrates 102, 104 and fixed therein by adhesive 110. Thus, proper alignment of the optical fibers 106 may be maintained by the V-grooves 108.

Referring to FIG. 2, the standard assembly process of a fiber capillary 200 can be described. First, a single fiber 202 is stripped of its plastic coating, revealing a portion of the optical fiber 202. The stripped portion of the optical fiber 202 is cleaned and manually inserted into a hole 204 formed in the fiber capillary 200.

Because the standard methods for assembling optical fibers to retaining devices (e.g., multi-fiber array substrates and capillaries) require manual insertion of the fiber into the retaining device, these methods are slow and are subject to error and variation. Therefore, there remains a need for a method for assembling one or more optical fibers to a retaining device.

### BRIEF SUMMARY

In a first aspect of the present invention, there is provided a method for attaching one or more optical fibers to a retaining device. The method includes: applying a fluid to a through hole in a retaining device id; disposing an optical fiber proximate an end of the through hole; developing a differential pressure in the fluid across the through hole; drawing a portion of the optical fiber into the through hole using a force associated with said differential pressure. In one embodiment, the fluid is a compressible fluid, such as air. In an alternative embodiment, the fluid is an incompressible fluid, such as water. In another embodiment, the retaining device is a capillary tube.

In a second aspect of the present invention, the method further includes: applying the fluid to a second through hole in the retaining device; disposing a second optical fiber proximate an end of the second through hole; developing the differential pressure in the fluid across the second through hole; and drawing a portion of the second optical fiber into the second through hole using a force associated with said differential pressure. In one embodiment, the retaining device is multi-fiber array substrate formed from an array of capillary tubes.

In a third aspect of the present invention, a system for attaching one or more optical fibers to a retaining device includes: a fluid in communication with a through hole in the retaining device; and a means for developing in said fluid a differential pressure across said through hole, said differential pressure providing a force for drawing a fiber into said through hole.

### BRIEF DESCRIPTION OF THE DRAWINGS

This disclosure will present in detail the following description of preferred embodiments with reference to the exemplary drawings wherein like elements are numbered alike in the several FIGURES:

FIG. 1 is an exploded perspective view of a multi-fiber array of the prior art;

FIG. 2 is a perspective view of a capillary tube and optical fiber of the prior art;

FIG. 3 is a cross-sectional plan view of a system for inserting an optical fiber into a capillary tube;

FIG. 4 is a cross-sectional plan view of the optical fiber inserted into the capillary tube;

FIG. 5 is a cross-sectional plan view of a system for inserting a plurality of optical fibers into a multi-fiber array substrate; and

FIG. 6 is a cross-sectional plan view of the plurality of optical fibers inserted into the multi-fiber array substrate.

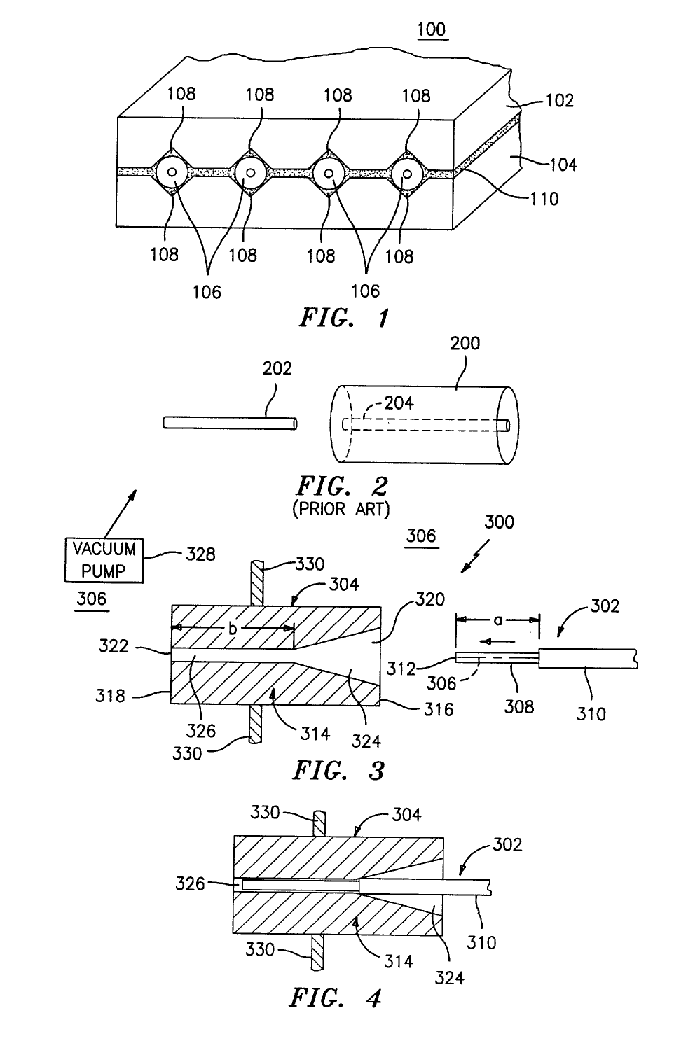

### DETAILED DESCRIPTION OF THE PREFERRED EMBODIMENTS

Some embodiments of the invention will now be described in detail in the following Examples. Referring to FIG. 3, a cross-sectional plan view of a system 300 for inserting an optical fiber 302 into a retaining device 304. In the embodiment shown, retaining device 304 is a capillary tube.

Optical fiber 302 includes a core 306, with cladding 308 disposed around core 306, and coating 310 disposed around cladding 308. Coating 310 may be a plastic jacket, an acrylate coating or the like. A portion of coating 310 is removed to reveal cladding 308. The stripped portion has a length “a” along the longitudinal axis of the optical fiber 302. Optical fiber 302 may be any known fiber for use in fiber optic systems.

An end 312 of fiber to be inserted in retaining device 304 may be flat cleaved or, preferably, the end 312 may be treated to increase the ease with which the fiber 302 slides into the retaining device 304. For example, the fiber end 312 may be flat cleaved and then heated to melting so that a convex cross section is formed at the end 312.

Retaining device 304 may be a generally cylindrical structure including a through hole 314 extending along its longitudinal axis from one end surface 316 to the opposite end surface 318. Through hole 314 has a fiber inlet end 320 positioned at end surface 316, and an opposite end 322, positioned at end surface 318. Inlet end 320 and outlet end 322 may be of the same diameter; however, it is preferred that the inlet end 320 have a diameter larger than that of the outlet end 322 to ease insertion of the optical fiber 302 into the through hole 314. In the embodiment shown, through hole 314 includes a conical portion 324 and a cylindrical portion 326. The inside diameter of cylindrical portion 326 is selected such that it is greater than or equal to an outside diameter of the core 306 and cladding 308 of the optical fiber 302 but less than the outside diameter of the coating 310 (i.e., less than the outside diameter of the coated portion of fiber 302). Cylindrical portion 326 of through hole 314 has a predetermined length “b” along its centroidal axis.

System 300 includes a fluid 306 in contact with the through hole 314 of retaining device 304 and at least a portion of optical fiber 302. Fluid 306 may be a compressible fluid (e.g., air), or an incompressible fluid (e.g., water). System 300 also includes a means for developing a differential pressure in the fluid 306 across through hole 314 such that the pressure of fluid 306 proximate fiber inlet end 320 of through hole 314 is greater than the pressure of fluid 306 at the opposite end 322 of through hole 314. In the embodiment of FIG. 3, the means for developing the differential pressure is shown as a vacuum pump 328 positioned one side of a seal 330, which is attached to the retaining device 304. The vacuum pump 328 evacuates fluid 306 at one side of the seal 330, creating a pressure differential across the seal 330 and across the through hole 314. It will be recognized that, rather than a vacuum pump located on the low pressure side of seal 330, a positive pressure pump may be used on the high pressure side of seal 330, or both types of pumps may be used together. Other pressurizing means may be used as well, such as diaphragms, plungers, and the like.

In operation, a fluid pressure differential is created across through hole 314, causing fluid 306 to pass through the through hole 314. Optical fiber 302, which is placed proximate to fiber inlet end 320 of through hole 314, is acted on by the drag of fluid 306 passing through the through hole 314. The force of the fluid 306 on the fiber 302 pulls the end 312 of fiber 302 into alignment with the through hole 314. As the end 312 of the fiber 302 is drawn into the cylindrical portion 326 of the through hole 314, the fiber 302 may plug the through hole 314, preventing fluid 306 from passing through. With the through hole 314 plugged, the force applied by the fluid 306 on the fiber 302 in response to the differential pressure acts to draw the end 312 of fiber towards the end 322 of through hole 314. Alternatively, if the diameter of the fiber 302 is such that fluid 306 continues to flow through the through hole 314 when end 312 of fiber 302 enters the cylindrical portion 326, the drag of the fluid 306 on the fiber 302 will act to draw the end 312 of fiber 302 towards the end 322 of through hole 314 in response to the differential pressure. It will be appreciated that one or more of these forces may act on the fiber 302 to draw the fiber 302 into through hole 314 in response to the differential pressure. It will also be appreciated that such forces may be supplemented by forces on the fiber 302 that are not developed in response to the differential pressure.

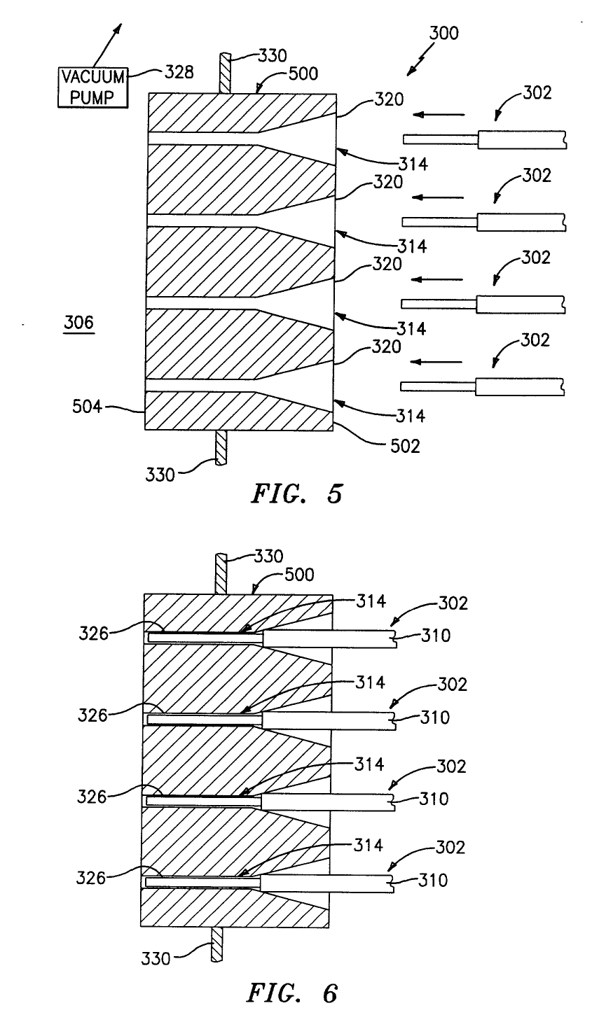

Referring to FIG. 4, the optical fiber 302 is shown inserted into the retaining device 304. As shown in FIG. 4, the stripped portion of fiber 302 is fully inserted into the cylindrical portion 326 of the through hole 314, and the coating 310 abuts a portion of the retaining device 304, acting as a mechanical stop. The length “a” of the stripped portion (shown in FIG. 3) determines the amount of fiber 302 that is drawn into retaining device 304.

The method applied by system 300 for inserting an optical fiber 302 into a retaining device 304 allows optical fiber 302 to be inserted in an automated manner. Because the method can be automated, it allows the assembly to be made faster and subject to less error and variation than is possible with manual assembly methods.

Referring to FIG. 5, system 300 is applied to insert a plurality of optical fibers 302 into a retaining device 500. In the embodiment shown in FIG. 6, retaining device 500 is a multi-fiber array substrate comprising an array of capillary tubes. Retaining device 500 is a structure having a plurality of through holes 314 disposed therein and extending from a surface 502 to an opposing surface 504. Each through hole 314 and optical fiber 302 are configured substantially as described above with reference to FIG. 3 and FIG. 4.

In operation, each optical fiber 302 is placed proximate to a fiber inlet end 320 of a corresponding through hole 314. A fluid pressure differential is created across seal 330, thus creating a pressure differential across through hole 314. Each fiber 302 is drawn into a corresponding through hole 314 under a force responsive to the differential pressure applied across the through hole 314, as described with reference to FIG. 3 and FIG. 4 hereinabove.

Referring to FIG. 6, the optical fibers 302 are shown inserted into the retaining device 500. The stripped portion of each fiber 302 is fully inserted into the cylindrical portion 326 of the associated through hole 314, and the coating 310 of each fiber 302 abuts a portion of the retaining device 500, acting as a mechanical stop. The length “a” of the stripped portion (as indicated in FIG. 3) determines the amount of each fiber 302 that is drawn into retaining device 500.

The method applied by system 300 for inserting a plurality of optical fibers 302 into a retaining device 500 allows the optical fibers 302 to be inserted in an automated manner. Because the method can be automated, it allows the assembly to be made faster and subject to less error and variation than is possible with manual assembly methods.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for attaching one or more optical fibers to a retaining device, the method comprising:
applying a fluid to a through hole in a retaining device;
disposing an optical fiber proximate an end of said through hole;
developing in said fluid a differential pressure across said through hole;
drawing a portion of said optical fiber into said through hole using a force associated with said differential pressure.

2. The method of claim 1, wherein said developing includes:
applying a vacuum to said fluid on an opposite end of said through hole.

3. The method of claim 1, wherein said developing includes:
applying a pressure to said fluid on said end of said through hole.

4. The method of claim 1, wherein said fluid is a compressible fluid.

5. The method of claim 4, wherein said fluid is air.

6. The method of claim 1, wherein said fluid is an incompressible fluid.

7. The method of claim 6, wherein said fluid is water.

8. The method of claim 1, wherein said retaining device is a capillary tube.

9. The method of claim 1, further comprising:
applying said fluid to a second through hole in said retaining device;
disposing a second optical fiber proximate an end of said second through hole;
developing said differential pressure in said fluid across said second through hole;
drawing a portion of said second optical fiber into said second through using a force associated with said differential pressure.

10. The method of claim 9, wherein said retaining device is a multi-fiber array substrate.

11. The method of claim 10, wherein said multi-fiber array substrate is an array of capillary tubes.

12. The method of claim 1, further comprising:
stripping a coating on said optical fiber revealing a stripped portion of said optical fiber, wherein said stripped portion of said optical fiber is said portion of said fiber drawn into said through hole.

13. The method of claim 12, further comprising:
sizing a diameter of said through hole to prevent an unstripped portion of said optical fiber from being drawn into said through hole under said force of said differential pressure.

14. The method of claim 1, wherein said through hole includes a conical portion and a cylindrical portion, said conical portion being positioned proximate said end of said through hole.

15. The method of claim 1, further comprising:
forming a convex surface on an end of said optical fiber to be drawn into said through hole.

16. The method of claim 15, wherein said forming includes:
cleaving said end of said optical fiber; and
heating said end to form said convex surface.

17. A system for attaching one or more optical fibers to a retaining device, the system comprising:
a fluid in communication with a through hole in the retaining device; and
a means for developing in said fluid a differential pressure across said through hole, said differential pressure providing a force for drawing a fiber into said through hole.

18. The method of claim 17, wherein said fluid is a compressible fluid.

19. The method of claim 18, wherein said fluid is air.

20. The method of claim 17, wherein said fluid is an incompressible fluid.

21. The method of claim 20, wherein said fluid is water.

22. The method of claim 1, wherein the retaining device is a capillary tube.

23. The method of claim 1, wherein the retaining device is a multi-fiber array substrate.

24. The method of claim 23, wherein said multi-fiber array substrate is an array of capillary tubes.
